(19) United States
(12) Patent Application Publication
(10) Pub. No.: US 2005/0162512 A1
(43) Pub. Date: Jul. 28, 2005

(54) Low vision video magnifier

(76) Inventor: Paul John Seakins, Christchurch (NZ)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/509,554

(22) PCT Filed: Mar. 28, 2003
(86) PCT No.: PCT/NZ03/00053

(30) Foreign Application Priority Data
Mar. 28, 2002 (NZ) 518092

(51) Int. Cl. H04N 9/47

(52) U.S. Cl. 348/62; 348/63

(57) ABSTRACT

A low-vision viewer magnifies the face-up source material in the visual field of a camera and displays the magnified image on a VDU or other display means. In a static mode, the camera captures and stores a high-resolution image of the source material. This high-resolution image can be manipulated and subsequently displayed on the VDU. In a live mode, the camera captures a low resolution image of the source material or a high resolution image of a section of the source material to provide a high frame rate for full motion video. In the live capture mode, the low-vision user can move their view around the source material and zoom in on a desired section of interest. The same camera is used in either static or live modes.

### TECHNICAL FIELD

This invention relates to a viewing device to enable people with low-vision to read printed material or view pictures and objects and in particular, but not solely, relates to a device to capture an image of the source material and manipulate this image into other formats.

### BACKGROUND ART

Low vision is defined as a condition where ordinary eye glasses, lens implants or contact lenses cannot provide sharp sight. Low vision can be caused by a variety of eye problems. Macular degeneration, diabetic retinopathy, inoperable cataracts, and glaucoma are but a few of the conditions that cause low vision. Individuals with low vision find it difficult, if not impossible, to read small writing or to discern small objects without high levels of magnification. This can limit their ability to lead an independent life.

One method of providing greater magnification is the use of a Video Magnifier. Such devices use a camera to image an object that is to be viewed. Video images taken from the camera are continuously displayed on a visual display unit (VDU), at a sufficient level of magnification for the user. The low vision user can then use their remaining sight to its best advantage when viewing very small objects or writing.

An example of existing prior art is shown in FIG. 1. It consists of three basic parts—a VDU 1, a head unit 2, and a base unit 3. The VDU 1 is mounted on the head unit 2, which is in-turn mounted above the base unit 3 using a vertical pillar 4. The VDU 1 may be a cathode ray tube or a flat-panel screen with a liquid crystal display panel type. The source material, for example a book, is placed on the base unit 3 which consists of a base and a table 5 moveable on an X-Y axis. The X-Y table 5 moves on runners 6 and 7 in the horizontal directions X and Y to scan the source material past the field of view. The camera 8 is part of the head unit 2 and consists of a mirror 11, a zoom lens 9 and an image sensor 12. The image sensor 12 is of the Charge Coupled Device (CCD) type. The zoom lens 9 provides a variable level of magnification or zoom of the image projected onto the image sensor 12. As the level of magnification is increased, the field of view on the page decreases. The image acquired by the camera is processed by circuitry located in the head unit 2, and then displayed on the VDU 1. The camera may be a colour or monochrome model, the latter being used in low cost video magnifiers. A light source (not shown in FIG. 1) is located in the head unit 2 and shines down onto the X-Y table 5 to illuminate the source material.

The user controls 10 are usually found on the front panel. A large zoom knob allows the user to increase and decrease the level of magnification from typically 3× to 45×. Older models have a manual focus knob while more recent models use a motorised auto-focus system. Another control often found on the front panel allows the user to select a viewing mode. These modes include photo, text, false colour, and inverse colour modes. The photo mode simply displays the scanned objects on the VDU 1 in grey-scale or colour without implementing any image processing, text mode enhances the image by using pixel level threshold filtering to create a bi-level monochrome image, false colour mode allows for easier reading of text by changing the bi-level colours to colours that are easier to read and the inverse colour mode allows for inversion of text and background colour to decrease image intensity and thus reduce eye strain. This list of features is by no means exhaustive of the features that could be incorporated into a video viewing system.

To use the prior art video magnifier, as described above, the user needs to place the source material face up on X-Y table 5. Part of the source material will be magnified on the VDU 1, when reading the text the user then needs to move the X-Y table 5 to the left and right while their eye follows the text. Moving the X-Y table 5 in this way can be tiring for the user's arms and their eyes. Scanning the viewing area across the text takes a great deal of concentration that could be better utilised for reading and comprehension. This movement also requires a certain level of coordination and dexterity that is often absent in elderly people. An example of this type of invention is disclosed in U.S. Pat. No. 3,819,855.

WO 00/36839 discloses an upward facing source material low vision viewer utilising a video camera. The camera is mounted on a stand above the source material and can view the entire page or view selected sections of the page by the camera lens pointing down from the stand and being moveable by hand. This requires a high level of dexterity from the user.

A related form of high-resolution face up scanner is used in museums and the like for scanning manuscripts. This is performed face up due to the delicate nature of such documents. Such scanners use linear sensors that are scanned across the image of the page. U.S. Pat. No. 5,616,914 is an example of such a device.

### DISCLOSURE OF INVENTION

It is an object of the present invention to provide a viewing device to allow persons of low-vision the ability to view small objects that goes some way to overcoming the abovementioned disadvantages in the prior art or which will at least provide the public with a useful choice.

Accordingly in a first aspect of the present invention consists in a low vision viewing apparatus that displays an image of an object, said apparatus comprising:
a camera, including a lens to define an image plane and an electronic image sensor located at the image plane for capturing a visual field;
a display means;
an electronic processing means controlled by a program, connected intermediate of said display means and said camera, which defines said visual field as a set of pixels and a subset of said set of pixels as a window-of-interest; and
a steering means to select said subset of pixels on said visual field which constitutes the window-of-interest.

In a second aspect the invention consists in a low vision viewing apparatus that magnifies and displays an image of an object on a display means, said apparatus incorporating a controller for electronically processing said image, said electronic processing modes including:
a live video capture and image display of said magnified image; and
a static image capture and image display of said magnified image.

### BRIEF DESCRIPTION OF DRAWINGS

FIG. 1 is a side elevation illustrating a video magnifier representative of the prior art.

FIG. 2 is a side elevation illustrating the preferred embodiment of the low vision viewing apparatus of the present invention.

FIG. 3a illustrates an image being imaged by the lens onto the image sensor as an object of the preferred embodiment of the low vision viewing apparatus.

FIG. 3b illustrates a view of the image plane, and the visual field.

FIG. 4a illustrates the image seen on the image sensor in full-scan mode.

FIG. 4b illustrates the image as displayed on the VDU in full-scan mode.

FIG. 5a illustrates the visual field of the image sensor and the window-of-interest in windowing mode.

FIG. 5b illustrates the image displayed on the VDU in window mode.

FIG. 6a illustrates the visual field of the image sensor in subsampling mode.

FIG. 6b illustrates the image displayed on the VDU in subsampling mode.

FIG. 7a illustrates the visual field of the image sensor and window-of-interest in hybrid mode.

FIG. 7b illustrates the image displayed on the VDU in hybrid mode.

FIG. 8 illustrates the flow of the software used for controlling the low-vision viewing apparatus.

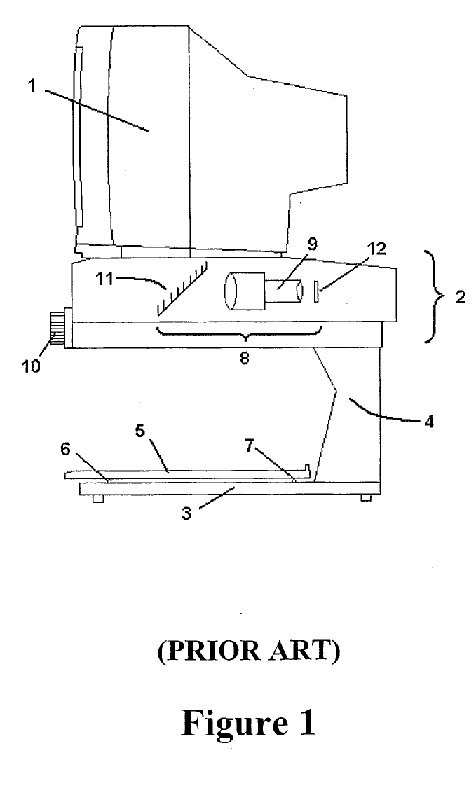

### BEST MODES FOR CARRYING OUT THE INVENTION

The low vision viewing apparatus of the present invention magnifies face-up source material, for example a book, in the visual field of a camera and displays a magnified image on a VDU or other display means. There are two different camera modes, a static mode and a live mode. The static camera, capture and display mode, captures and stores a high-resolution image of the source material. This high-resolution image can be manipulated and subsequently displayed on the VDU. The high-resolution image is large, so it is slow to read from the sensor. The live video, capture and display mode captures full-motion video, by repeatedly taking either low resolution images of the source material, or high resolution image of a section of the source material. These images are much smaller than the full high-resolution image of the source material, so they are very fast to read from the sensor. In this way the images that are captured and displayed are fast enough to give full-motion video. In live capture mode, a user of the viewing apparatus can move their view around the source material and zoom in on a desired section of interest. The same camera and the same apparatus can be used in to operate in either static or live modes. The low vision viewing apparatus is used by low vision users to enable them to view source material.

The static camera capture mode captures and stores a high-resolution image of the source material and uses software to control the manipulation of the high-resolution image. Precise pixel data is obtained from the image sensor and is manipulated for optimum viewing for the user. Forms of manipulation include changing the orientation of the source material, finding characters and rearranging them, displaying characters in a different font and Optical Character Recognition (OCR). OCR extends the use of the magnifier for poor or no vision users by generating an output in braille or speech.

The live video capture mode requires a level of magnification to be selected by the user. The possibilities are a low magnification (subsample mode), medium magnification (hybrid mode) or high magnification (window mode). To smoothly change between these magnification levels, or modes, a digital zoom is used. The digital zoom increases the magnification of the image using linear scaling and interpolation. With either static or live capture mode the image can also be digitally processed to improve the image or to increase readability. For example, the image can be improved by removing image distortion caused by the lens and the imaging configuration, or lighting non-uniformities can be corrected by brightness correction. Readability of text in an image can be enhanced for low-vision users by using contrast enhancement and false colours.

Physical Structure

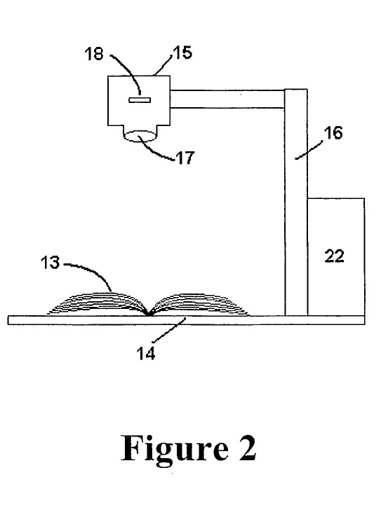

FIG. 2 depicts the preferred embodiment of the present invention low vision viewing apparatus. The source material 13 is placed on the base 14 facing upwards towards a camera 15. The camera 15 is held above the source material 13 by the arm 16. This arm 16 may be fixed or adjustable. An image sensor 18 is provided in vertical alignment with lens 17, and both the sensor 18 and lens 17 are enclosed within the camera 15. The light reflected from the source material 13 is focused by the lens 17 and forms an image of the source material 13 on the image sensor 18. The image captured by the image sensor 18 is then transmitted to electronic processing means 22, which may consist of digital logic, memory, a microprocessor and associated software for processing before being transmitted to the VDU (not shown). Alternately, the electronic processing means 22 processes the captured image and the resulting data is conveyed to the user by the speakers or some other form of output device.

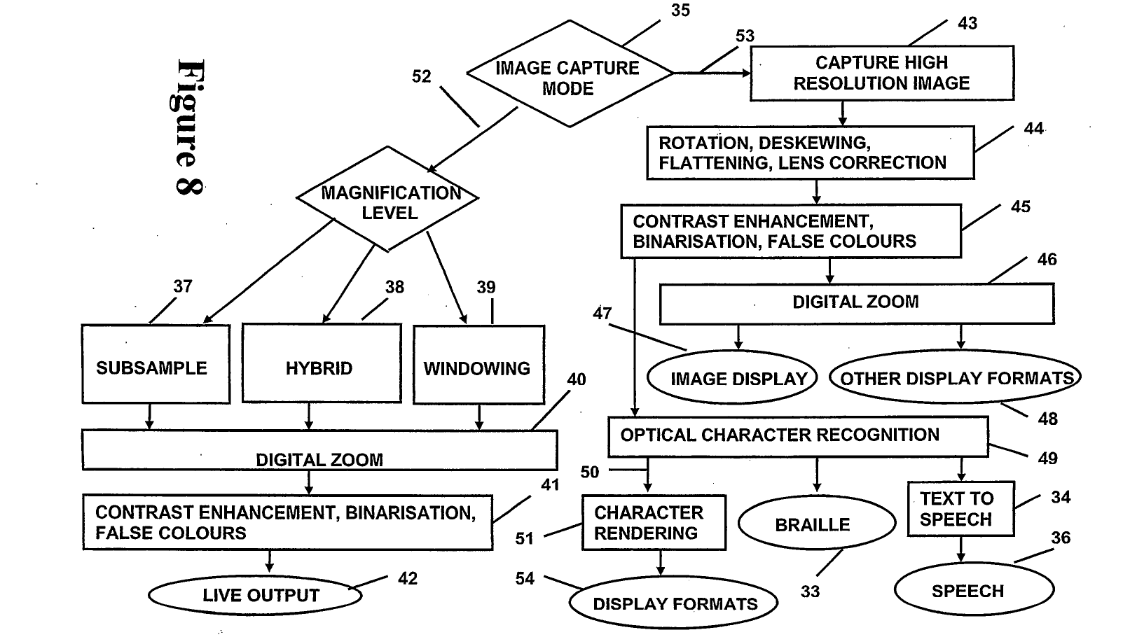

A software program and associated hardware for controlling the video magnifier is located within the electronic processing means 22. The processes for controlling the video magnifier and manipulating image data are illustrated in FIG. 8 and will be described in detail below.

The camera 15 can be mounted in many ways. Typically the camera 15 is mounted above the source material 13; with its field of vision of lens 17 aimed at the upward facing source material 13. Alternately, the camera 15 may be adjusted by the user to a variety of angles allowing for acquisition of images that are sideways or are at a distance from the camera 15. For example, the user may view an object on a wall.

The camera 15 in the preferred embodiment consists of one camera which can operate in two different acquisition modes, the first being a static image mode and the second being a live video mode.

In an alternative embodiment, two cameras may be used, one for static capture of still-life pictures and the other for live video capture. These cameras will have the same function and modes as described above. In addition a live camera could be located remotely from the static image capture system, but attached by a cable to capture images of a distant object.

The lens 17 of the camera is preferably a single focal length lens. In an alternate embodiment an adjustable zoom type lens may be used. A single focal length lens is used to reduce system complexity and cost of the system. The focussing mechanism of lens 17 is preferably auto-focus, that is, automatically adjusted by the electronic processing means 22 to achieve optimum image sharpness, but alternatively it may be fixed or manually adjustable by the user.

In an auto-focus system, the focus of the lens 17 is adjusted to achieve maximum sharpness when taking an image of the whole source material; however it may not be possible to obtain accurate focus for all points of the image at any one time due to the limited depth of focus of the lens, especially when the source material is not flat. Therefore a multi-focus system may be used to extend the depth of focus of the system. To implement this, a series of images are taken, each with a different focus adjustment. The images are broken into sections and the sharpness of each section for the image is measured. The resulting image is achieved by combining the best (sharpest) image sections taken by the multi-focus system.

The lens may have a fixed aperture, manual iris adjustment, or auto-iris adjustment. Auto-iris ensures that the images are optimally exposed, but the complexity may not be warranted in this system because the light level is expected to be relatively uniform.

Image Sensor

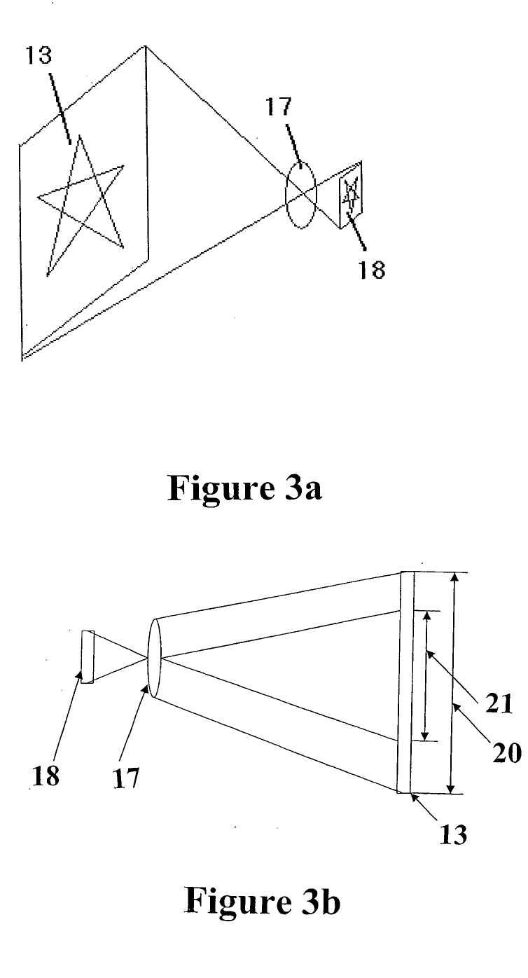

In the preferred embodiment of low vision viewing apparatus of the present invention, the image sensor 18 is comprised of a single high-resolution image sensor, as is shown in FIGS. 3a and 3b. The image of the source material 13 passes through the lens 17 and falls incident onto the light-sensitive area of the sensor 18. The image of the source material 13 rotates 180 degrees as it passes through the lens 17. The plane of the image sensor where the image falls is known as the image plane. The part of the image incident on the image sensor 18 is known as the visual field. The visual field is defined as a set of pixels (created by the image).

FIG. 3b shows the source material 13 being imaged onto the sensor 18 by lens 17. If the whole sensor 18 is read out, then an image of the whole source material will be acquired. However we can define a subset of pixels known as a window-of-interest 20, which will see only a small section 21 of the source material 13. the use of windowing and subsampling readout modes of the sensor to achieve different levels of magnification will be described in detail later.

The image sensor 18 may alternatively consist of a plurality of low-resolution image sensors. These low-resolution image sensors are optically “butted” together to form a single high-resolution image sensor. In an alternate embodiment, the sensor 18 may consist of a low-resolution image sensor that is “micro-scanned” to increase individual resolution. Micro-scanning involves moving the low-resolution image sensor by sub-pixel amounts across the source material and acquiring images at different positions. These acquired images are combined to form a single high-resolution image. In yet another alternate embodiment of the present invention the image sensor 18 may be comprised of a low-resolution sensor that is significantly smaller than the image plane. The low-resolution sensor is mechanically moved around the image plane to capture various images of the source material. These low-resolution image sections can then be combined to form a single high-resolution image of the entire image of the source material.

The image sensor 18 is preferably of the Complementary Metal Oxide Semiconductor (CMOS) type; alternatively it may be of the Charge Coupled Device (CCD) type. The CMOS image sensor has two main advantages over the CCD image sensor. The CMOS image sensor is made from standard fabrication processes so allowing for lower production costs. It also has the ability to read the pixels of the sensor in any sequence compared to the CCD image sensor where pixels must be read in a sequential order. It is preferable to use a CMOS type image sensor as the pixels can be read in any sequence allowing one camera to have both static and live acquisition modes. This allows for a lower cost system compared to using separate cameras for each mode. The reading of pixels in any sequence leads to a plurality of sensor read out modes.

Image Capture Modes

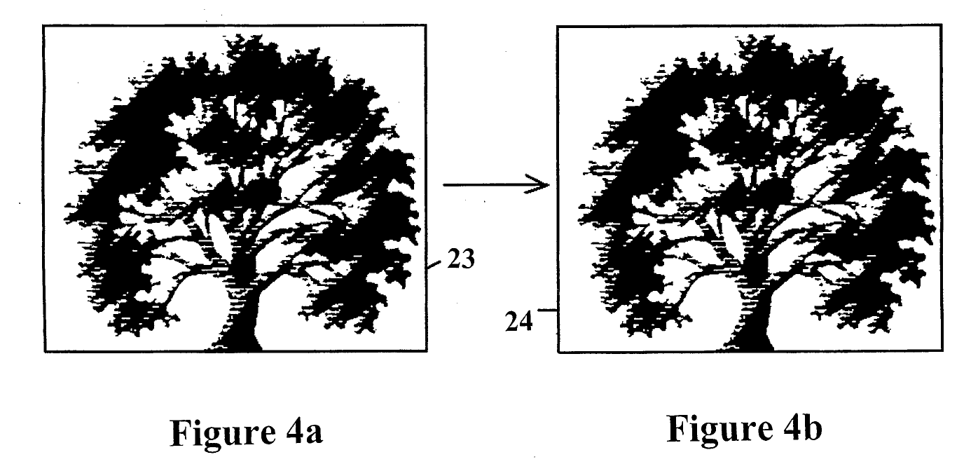

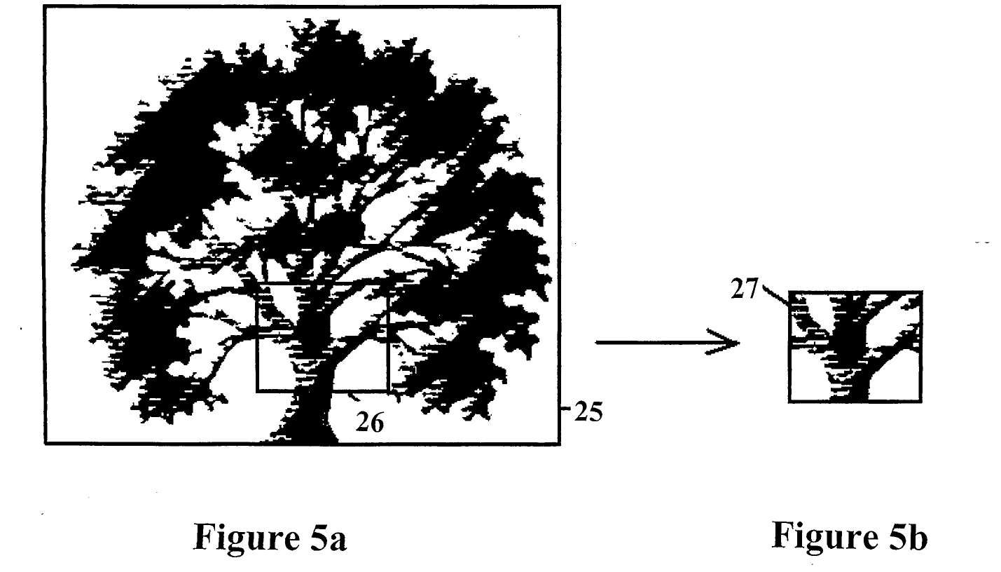

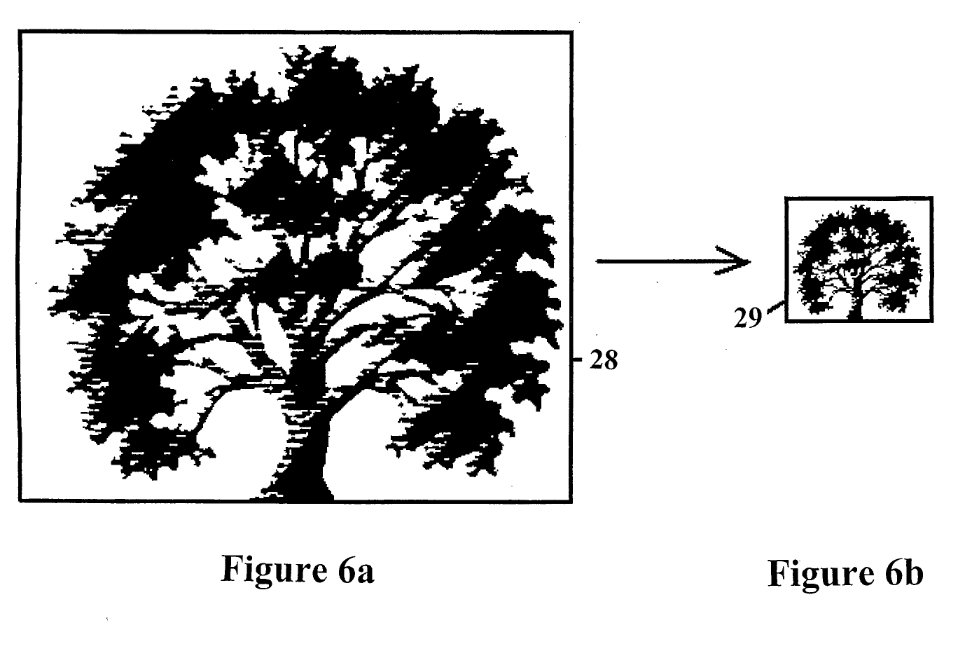

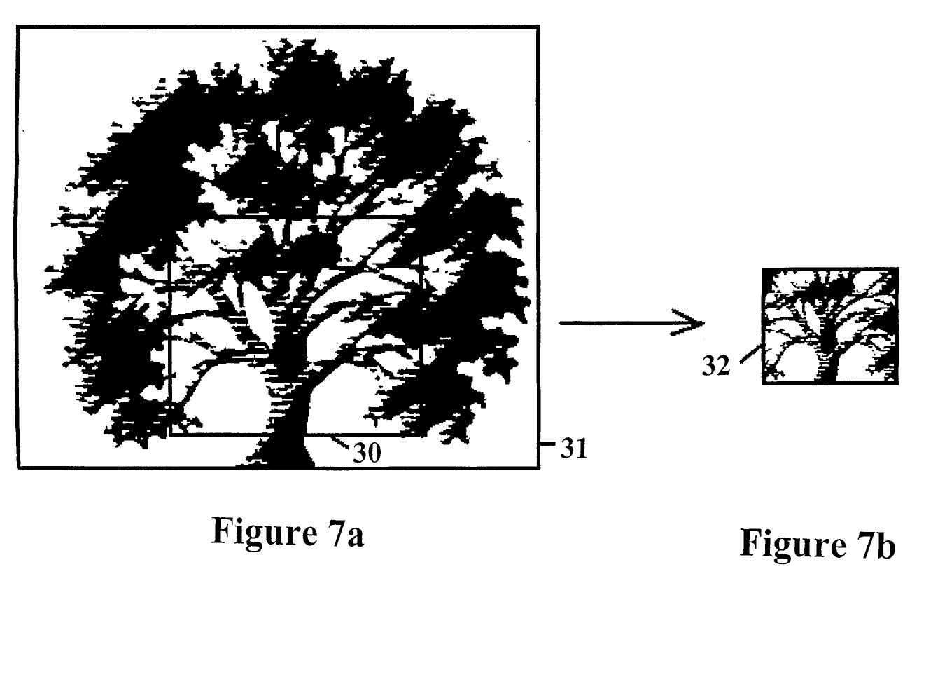

Reading the pixels from the image sensor in different sequences allows for different modes. In particular, it allows for static and live capture display modes. The static image capture mode 53 is shown in FIGS. 4 and 8 and live capture modes 52 are shown in FIGS. 5 to 8. The live capture mode 52 is comprised of subsample 37, hybrid 38 and windowing 39 modes. These are illustrated as windowing mode in FIGS. 5a and 5b, subsampling mode in FIGS. 6a and 6b, and hybrid mode in FIGS. 7a and 7b. Each of the images shown in FIGS. 5b, 6b and 7b fill the entire viewing area of the VDU.

FIGS. 4a and 4b illustrates the static mode of the viewer of the present invention, otherwise known as the full-scan read out mode. In particular, the image input 23 to the viewer of the present invention and the output 24 that is stored and may be displayed to the user (FIGS. 4a and 4b). This occurs, referring to FIG. 2, when all the data from the image sensor 18 is read out from the sensor 18 and stored in electronic processing means 22, where it can be processed and displayed on the VDU (not shown). FIG. 4a shows the entire picture 23 that is read in from the image sensor, which also has the same view as the lens i.e. the visual field is the same as the image plane. The entire image 24 as seen in FIG. 4b is then processed and can be displayed 24 on the VDU. The image is of a high-resolution and all of its pixels are read out, this results in a picture with a lot of detail and a low frame rate. The image 24 takes a long time to read out due to the limited data readout rate from the image sensor and the large amount of data being read out. Thus a high-resolution static image 24 is produced and stored in memory of the viewer of the present invention.

In order to implement windowing, or hybrid modes, a window-of-interest is defined in the visual field of the sensor. A window-of-interest is defined as a subset of the set of pixels that makes up the visual field. Typically it is a section of the visual field that is of interest. The size of the window-of-interest may vary but is dictated by the size of the subset of pixels and the amount of time it takes to read them. If there is too much data, the image seen by the user will be slower than real time and thus create problems.

Windowing mode is illustrated in FIGS. 5a and 5b. FIG. 5a shows the desired window-of-interest 26 on the visual field 25. The window-of-interest 26 is read out and displayed on the display means (FIG. 5b). The image 27 produced is of the same quality as the full-scan image but smaller in size, thus it is faster to read from the sensor, giving an increased frame rate. The frame rate is increased by reducing the number of pixels read per frame while maintaining the pixel readout rate. The user can move the window-of-interest 26 using a hand control or similar device, for example a joystick, a trackball, a set of buttons, a mouse, a touch screen or similar device. This allows the user to scroll around the image in real time. Windowing mode provides a high level of magnification.

Subsample mode is illustrated in FIGS. 6a and 6b. The image 29 on the display is a less detailed view of the visual field 28. Certain pixels, for example every second pixel, are skipped while reading pixels out of the image sensor so the image acquired 29 is smaller and has a reduced resolution. This is also known as compressing the image according to a predetermined pattern. The number of pixels read out per frame is less than the full-scan mode thus allowing for an increased frame rate. Subsample mode allows for an increased frame rate while producing a full-page overview with reduced detail. This provides a way to preview the full-page image. Subsample mode provides a low level of magnification.

The subsample and windowing modes are combined to produce a hybrid mode, as illustrated in FIGS. 7a and 7b. In the hybrid mode the window-of-interest 30 is larger than the window-of-interest in the windowing mode, and when the data is read out certain pixels are skipped, similar to the subsample mode. The hybrid mode allows for a high frame rate while viewing an area of interest that is larger than the windowing mode view and smaller than the subsample mode. Hybrid mode provides a medium level of magnification. The window-of-interest 30 may be moved around the visual field 31 by the user in the same way described previously using a hand control, for example a joystick, a trackball, a set of buttons, a mouse, a touch screen or similar device.

The windowing, subsample, and hybrid modes allows the user to view either a full page or sections of the page, and provide several different levels of discrete magnification at a high frame rate. The high frame rate means the images acquired are live video and the different levels of magnification are performed without the use of an analogue zoom lens. To allow a smooth continuous transition between discrete magnification levels, and to provide a higher magnification than provided in windowing mode, a digital zoom is used.

Digital Zoom

In the preferred embodiment of the low vision viewing apparatus, windowing, subsample and hybrid modes are used in conjunction with a digital zoom to duplicate the operation of a traditional zoom lens based system. This allows the use of a monofocal lens as opposed to a zoom lens. The use of a monofocal lens enables the low-vision video magnifier camera assembly to be smaller, lighter, more reliable, and easier to manufacture.

The digital zoom magnifies the image displayed on the display by an arbitrary amount, specified by the user, by using two-dimensional linear scaling with interpolation. The type of interpolation is preferably linear but it could also be nearest-neighbour or cubic spline interpolation.

With reference to FIG. 8, the operation of live video capture mode 52 will now be described. The user selects a desired level of magnification. The electronic processing module selects the capture and display mode 37, 38 or 39 for the image sensor that has the highest level of magnification that does not exceed the level selected by the user. If the magnification provided by the capture and display is still below the user-selected level, then digital zoom 40 is used to magnify the image to the desired level.

Image Processing

Image processing may be performed in both live 52 and static capture 53 modes because both modes provide a digital output. The high-and low-resolution digital images in the preferred embodiment of the viewer of the present invention are then digitally processed and enhanced to improve readability and comprehension for the low-vision viewer.

In static 53 and live video mode 52 there are several forms of image manipulation 41 of the live video low-resolution image available to the user. These include applying contrast enhancement, binarisation, and false colours to the image before the image is displayed.

Binarisation is a process that converts all pixels that have grey-scale values that are darker than a threshold to be black, and all pixels that are lighter than the threshold to be white. If the image is lit uniformly and the text contrast is high, then the threshold level may be uniform across the image. However if the brightness across the image is not uniform, or the text contrast is low then it is better to use a non-uniform threshold across the image, where the threshold levels are chosen to give optimum readability of the text.

Text Processing

In static mode 53 the high-resolution image may be manipulated in many different ways. For example, the whole or sections of the image can be automatically rotated 90 or 180 degrees to cope with upside-down or landscape formatted documents. This is an important feature as low vision users may not be able to tell the orientation of a document without magnification. The image could also be de-skewed by rotating the image slightly to straighten it. This is important as with a face-up video magnifier it may not be easy for the user to determine the visual field of the camera, and therefore the document can be easily misaligned. Another problem is curvature of the document; this is when the source material does not lie flat on the viewer base, the text can be straightened by texture mapping 44.

Problems tend to occur when capturing a whole page image; these problems include image distortions such as barrel distortion. Barrel distortion results from using a wide-angle lens to capture an entire image of the source material. This can be removed by using a lens-correcting algorithm 44, for example barrel-to-square compensation; other forms of distortion are possible therefore other forms of correction are used.

The user is able to select from a number of different viewing modes when in static capture mode. The simplest way of displaying the high-resolution image obtained from the full-scan mode 43 is to display 47 it on the screen directly. In most cases the image will be larger than the VDU screen resolution, so only part of it will fit on the VDU screen. The digital zoom function 46 allows the user to move the viewing area around the full image and digitally zoom 46 in and out of the image. The viewed section can be moved around in response to a hand controller, and can be zoomed in and out using digital zoom.

Page Segmentation

The simple image display mode 47 for viewing the high-resolution image may not be the optimum display mode for all users. For instance, an eye condition may limit the useable field of view, in this situation it would help if all text on the source material appeared in the same position for viewing. Also it takes mental and physical effort to scan the viewable area back and forth while reading the magnified page. It would be advantageous to be able to recognise the areas of an image that represent word or letters and then rearrange these on the screen. In this way words or letters can be displayed in other text display formats 48. Other text formats can be implemented by using page segmentation to recognise the location of text (letters and words) and pictures in the image, identifying the correct reading order for the text, copying the text and pictures from the digital page image, scaling to the required size, and then displaying them on the screen in the required format and correct reading order. Page segmentation is the process of breaking a page image down into areas of text, pictures and formatting. The text areas can be further broken down into lines, words and characters. Page segmentation is often the first step in OCR.

One display format 48 will have letters and words pasted onto the screen from left to right until they reach the right-hand side of the screen, where they start another line underneath the first line. In this viewing mode the user scrolls up and down the column of text on the screen. An alternate screen format 48 is when a single or a plurality of words are flashed up on the screen in the same place at a rate adjustable by the user. The rate may be constant, or it may be proportional to the length of time it would take to read each word. In yet another screen format 48 the text scrolls horizontally past the user on the screen. In any of these screen formats, the user is able to adjust the spacing between letters and/or the character size as this can increase readability, comprehension and reading endurance. The character size can be altered using digital zoom 46. To change the separation of characters words must be further broken down into individual characters, which are displayed on the display with an adjustable amount of additional space between them. It would also be advantageous to automatically scale the text so that all characters are displayed at the height for optimum readability by the user, regardless of the original character size. The optimum character size would be adjustable by the user to suit their preferred reading size.

A further improvement would be to scale the character sizes so that the range of text sizes was compressed. In this way all characters would be of a similar size, but headings would appear slightly larger than the surrounding text (instead of many times larger as they may be in the original image).

The main disadvantage of image display modes 47 and 48 are that the character viewing quality is not improved. Increasing the magnification using digital zoom 46 magnifies any imperfections in the original scanned characters. Another disadvantage is the inability to alter the typeface of the characters to one that is easier for the user to read. OCR offers solution to these problems.

OCR

In the present invention the high-resolution digital image is processed using OCR 49 to provide improved text presentation formats for the user. OCR 49 has the ability to recognise the characters in the image and their correct reading order and provide an output form such as formatted or unformatted ASCII 50 thus providing a wider flexibility over the current presentation format on the display. All the previously mentioned modes of text presentation 47, 48 can be extended to use the ASCII characters from OCR. These characters can be rendered 51 on the VDU using a clean typeface or in a different typeface to provide ease of reading, and then displayed 54 in any of the previously described display formats.

Display modes for the ASCII text 50 or the OCR text 49 consists of the user specifying a viewing typeface and the text is changed to this selected typeface. Another display mode consists of arranging the letters in sequence on the display from left to right, upon reaching the right-hand side of the screen, forming a new line below the newly completed line. The user may then scroll up and down this screen. Alternately, the text may continue in one long line across the screen and the low-vision user may scroll across the screen to view all the words. Yet another display mode is to display single words or a plurality of words on the screen in sequence. Each word is displayed on the screen for a specified period of time and then the next word replaces it on the screen. The length of time each word is displayed may be a constant, or it may be proportional to the length of time it takes to read each word.

Regardless of the text presentation format (47, 48, 54, 33 or 36) that is chosen, the user will be able to use manual controls to change the portion of the text from the source image that is being presented. In this way they will be able to manually move through the text while reading or listening, and they can select a section of interest to read.

An alternative to manual control of the text for reading is to use automatic reading. Automatic reading allows the subset of text that is being presented to move at a constant rate through the recognised text from the source material. The user will have the capability to start stop the automatic reading, and to select the speed of movement. Automatic reading allows the user to read the imaged text more easily, without constantly using their hands to control the text. The reading order for automatic reading is determined using either page segmentation or OCR.

The ASCII text data 50 resulting from the OCR process 49 can be stored with much less memory than storing the original high-resolution image. This makes the data versatile for transmitting, storing and editing. Alternately this data could be translated into Braille 33 for display on a Braille cell or translated to speech 34 to be used by a speech synthesiser 36. These alternate embodiments expand the utility of the low vision viewing apparatus to those of very poor vision or no vision.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A low vision viewing apparatus that displays an image of an object, said apparatus comprising:
a camera, including a lens to define an image plane and an electronic image sensor located at the image plane for capturing a visual field providing an output set of pixels representative of said visual field depending on input as to specific pixels or ranges thereof;
a display means configured to provide a representation of a window of interest;
an electronic processing means controlled by a program, connected intermediate of said display means and said camera, which defines said visual field as a set of pixels and a subset of said set of pixels as said window-of-interest; and
a steering means to select said subset of pixels on said visual field which constitutes the window-of-interest,
wherein said processing means selectively acquiring said subset of said set of pixels from said camera depending on user input from said steering means and pre-programmed instructions.

2. A low vision viewing apparatus according to claim 1 wherein:
said electronic processing means includes storage means; and
said electronic processing means controlled by said program that causes said processing means to apply digital magnification to said stored set of pixels to a desired magnification level selected by said low-vision user, said electronic processing means displaying a magnified image of said visual field image on said display means.

3. A low vision viewing apparatus according to claim 2 wherein said electronic image sensor is a high-resolution image sensor that captures a high-resolution image.

4. A low vision viewing apparatus according to claim 1 wherein said electronic image sensor is a low-resolution image sensor that captures a plurality of low-resolution images by moving a low-resolution image sensor by sub-pixel amounts and combining said low-resolution images to create a high-resolution image.

5. A low vision viewing apparatus according to claim 1 wherein said electronic image sensor consists of a plurality of low-resolution image sensors that are optically “butted” together to create a single high-resolution image sensor and captures a high-resolution image.

6. A low vision viewing apparatus according to claim 1 wherein said electronic image sensor is a low-resolution image sensor that is moved within said image plane of said lens to capture a plurality of low-resolution images, and combining said low-resolution images to create a high-resolution image.

7. A low vision viewing apparatus according to claim 3 wherein said electronic processing means moves said window-of-interest on said electronic image sensor by reading said subset of pixels from said electronic image sensor and displaying said window-of-interest on said display means.

8. A low vision viewing apparatus according to claim 3 wherein said electronic processing means moves said electronic image sensor within said image plane of said lens and displays said window-of-interest on said display means.

9. A low vision viewing apparatus according to claim 3 wherein said electronic processing means moves said electronic image sensor within said image plane of said lens and displays said high resolution image on said display means.

10. A low vision viewing apparatus according to claim 7 wherein said low-vision user controls the location of said window-of-interest or said electronic image sensor by a device selected from the group consisting of a trackball, a joystick, a set of buttons, a mouse, a touch screen, or a touch tablet.

11. A low vision viewing apparatus according to claim 1 wherein said electronic processing means subsamples said window-of-interest by reading said subset of pixels as defined by a previously defined regular pattern and displays a compressed image on said display means.

12. A low vision viewing apparatus according to claim 3 wherein said electronic processing means subsamples said high-resolution image by reading said set of pixels as defined by a previously defined regular pattern and displays said compressed image on said display means.

13. A low vision viewing apparatus according to claim 12 wherein said program controls said processing means to apply digital magnification to said high-resolution compressed image to a desired magnification level selected by said low-vision user and displays the digitally magnified image on said display means.

14. A low vision viewing apparatus according to claim 7 wherein said program controls said processing means to apply digital magnification to said window-of-interest to a desired magnification level selected by said low-vision user and displays the digitally magnified image on said display means.

15. A low vision viewing apparatus according to claim 11 wherein said program controls said processing means to apply digital magnification to window-of-interest compressed image to a desired magnification level selected by said low-vision user and displays the digitally magnified image on said display means.

16. A low vision viewing apparatus according to claim 12 wherein said program controls said processing means to select said high-resolution compressed image based on said desired level of magnification selected by said low-vision user, and displays selected image on said display means.

17. A low vision viewing apparatus according to claim 7 wherein said program controls said processing means to select said window-of-interest based on said desired level of magnification selected by said low-vision user, and displays selected image on said display means.

18. A low vision viewing apparatus according to claim 11 wherein said program controls said processing means to select said window-of-interest compressed image based on said desired level of magnification selected by said low-vision user, and displays selected image on said display means.

19. A low vision viewing apparatus according to claim 13 wherein said program controls said processing means to select said desired magnification level for each letter so that text in said visual field and said window-of-interest is magnified to a preselected size on said display means.

20. A low vision viewing apparatus according to claim 13 wherein said program controls said processing means to select said desired magnification level for each letter so that the text in said visual field and said window-of-interest is reduced to a preselected size on said display means.

21. A low vision viewing apparatus according to claim 13 wherein said digital magnification is implemented using two dimensional scaling by a form of interpolation selected from the group consisting of linear interpolation, nearest-neighbour interpolation, or cubic spline interpolation.

22. A low vision viewing apparatus according to claim 12 wherein said program controls said processing means to automatically adjust the brightness and contrast of said high-resolution compressed image on said display means.

23. A low vision viewing apparatus according to claim 7 wherein said program controls said processing means to automatically adjust the brightness and contrast of said window-of-interest on said display means.

24. A low vision viewing apparatus according to claim 11 wherein said program controls said processing means to automatically adjust the brightness and contrast of said window-of-interest compressed image on said display.

25. A low vision viewing apparatus according to claim 2 wherein said electronic processing and storage means successively adjusts the focus of said lens and captures an image at different focus points, analyzes said different focused images to extract the image sections of each different focus image which are the sharpest, and combines said image sections to yield a high-resolution image with extended depth of focus.

26. A low vision viewing apparatus according to claim 3 wherein said program controls said processing means to implement pixel level binarisation on said stored high-resolution image based on a uniform pixel threshold level.

27. A low vision viewing apparatus according to claim 3 wherein said program controls said processing means to implement pixel level binarisation based on a pixel threshold level which varies over said high-resolution image to provide optimum binarisation in the presence of brightness variations.

28. A low vision viewing apparatus according to claim 3 wherein said program controls said processing means to use page segmentation to identify the location of letters and a reading order for said letters in said stored high-resolution text and display said letters on said display means in a predefined pattern.

29. A low vision viewing apparatus according to claim 28 wherein said program controls said processing means to arrange said letters into words and displays said words on said display means in a predetermined sequence wherein each said word replaces the previous said word after a predetermined time period.

30. A low vision viewing apparatus according to claim 28 wherein said program controls said processing means to arrange words on said display means in a predetermined sequence, wherein said words are displayed from one side of said display means to the opposite side of said display means.

31. A low vision viewing apparatus according to claim 28 wherein said program controls said processing means to separate said letters by displaying said letters with a predetermined space between each said letter.

32. A low vision viewing apparatus according to claim 28 wherein said program uses a device to determine the section of said stored high-resolution image text displayed on said display means by a device from the group consisting of a trackball, a joystick, a set of buttons, a mouse, a touch screen, or a touch tablet.

33. A low vision viewing apparatus according to claim 3 wherein said program automatically moves through said stored high-resolution image text, said movement based on said reading order of said text on said display means.

34. A low vision viewing apparatus that magnifies and displays an image of an object on a display means, said apparatus incorporating a controller for electronically processing said image, said electronic processing modes including:
a live video capture and image display of said magnified image; and
a static image capture and image display of said magnified image.

35. A low vision viewing apparatus according to claim 34 wherein said static image capture mode allows a user to adjust the magnification of said static image on said display means.

36. A low vision viewing apparatus according to claim 34 claims 34 or 35 wherein said static image capture mode allows the user to navigate said static image on said display means.

37. A low vision viewing apparatus according to claim 34 wherein said static image capture mode analyzes text present in said static image and provides for the display of said text on said display means in a plurality of predetermined formats.

38. A low vision viewing apparatus according to claim 34 wherein said static image capture mode analyzes the reading order of said text, and facilitates the user to navigate around said static image on said display means by using a controller to determine the section of said static image to be displayed on said display means.

39. A low vision viewing apparatus according to claim 34 wherein said static image capture mode analyzes the reading order of said text and allows automatic movement of the section of said static image visible on said display means, using a controller to determine the speed and direction of said automatic movement.

40. (canceled)
